(19) United States
(12) Patent Application Publication
(10) Pub. No.: US 2001/0013726 A1
(43) Pub. Date: Aug. 16, 2001

(54) SPINDLE MOTOR

(76) Inventors: MASAYUKI KATAGIRI, NAGANO (JP); HIROMITSU TAKEI, NAGANO (JP)

Correspondence Address: SUGHRUE MION ZINN MACPEAK AND SEAS PLLC, 2100 PENNSYLVANIA N W, WASHINGTON, DC, 20037

(21) Appl. No.: 09/340,671

(22) Filed: Jun. 29, 1999

(30) Foreign Application Priority Data
Jun. 30, 1998 (JP) HEI. 10-183515

(51) Int. Cl. H02K 7/00; H02K 5/16

(52) U.S. Cl. 310/67 R; 310/90

(57) ABSTRACT

In a spindle motor 10 with brushes, the output end portion of the motor shaft 2 is protruded through a shaft pull-out hole 48 which is opened in the upper end surface of a motor casing 40, and a radial bearing 22 supporting the output end portion of the motor shaft 20 is held on a mounting board 50 secured to the upper end surface of the motor casing 40.

### BACKGROUND OF INVENTION

1. Field of the Invention

This invention relates to a spindle motor which is mounted on a body unit such as a disk drive adapted to rotate a data record disk such as CD-ROM, DVD and MD, and more particularly to a motor shaft supporting structure in the spindle motor.

2. Related Art

An example of a spindle motor mounted on a body unit such as a disk drive device is a small DC motor with brushes as shown in FIG. 5. The spindle motor 80 comprises: a motor body 80A with the output end portion of a motor shaft 20 protruded from the upper end surface 88 of a motor casing 85; and a mounting board 90 which is mounted on the motor casing 85 with screws 96 in such a manner as to cover the upper end surface 88 of the motor casing 85. The mounting board is used as a mounting section of the motor body 80A with respect to the motor mounting section 99 of the body unit. That is, a mounting board 90 is secured to the motor mounting section 99 of the body unit with screws or the like. The above-described structure for mounting the motor body 80A on the body unit has been disclosed by Unexamined Japanese Patent Publication Hei. 9-35455. The structure is popularly employed in the field of a body unit whether the spindle motor has brushes or has no brushes.

In the above-described motor, the motor shaft 20 must be perpendicular to the motor mounting section 99. Therefore, heretofore, first a bearing holding hole 83 is formed in the upper end surface 88 (the upper plate 850) of the motor casing 85 in such a manner that the former forms right angle with the latter, and then a radial bearing 82 is fitted in the bearing holding hole 83 so that the motor shaft 20 forms right angles with the upper end surface 88 of the motor casing 85. Next, the mounting board 90 is secured to the upper end surface 88 of the motor casing 85 in such a manner that the former 90 is in close contact with the latter 88, whereby the motor shaft 20 forms right angles with the mounting board 90.

In the body unit on which the spindle motor 80 is mounted, it is desired that the squareness of the motor shaft 20 (the axial squareness) on the body unit is within 0±0.15° or within 0±10°. However, with the conventional structure that the motor shaft 20 is supported by the radial bearing 82 which is held in the upper end surface 88 of the motor casing 85, it is difficult to obtain such a high axial squareness. That is, in the conventional motor shaft (20) supporting structure, after the squareness of the motor shaft 20 with respect to the upper end surface 88 of the motor casing 85 is obtained, the mounting board 90 is secured so that the former 90 is in close contact with the upper end surface 88 of the motor casing 85, so that the squareness of the motor shaft 20 with respect to the mounting board 90 is obtained. Therefore, when the motor body 80A is mounted on the body unit through the mounting board, the deviation of the squareness is such that the deviation in parallelism of the mounting board 90 with respect to the upper end surface 88 of the motor casing 85 is added to the deviation in squareness of the motor shaft 20 with respect to the upper end surface 88 of the motor casing 85. Especially, since the specification of the mounting board 90 depends on the kind of a body unit on which the motor body 80A is mounted, in all specifications it is difficult to obtain the squareness of the motor shaft 20 with high accuracy.

In a disk drive device, a disk placing turn table (not shown) is directly mounted on the output shaft side (the upper side of FIG. 5) of the motor shaft 20. Therefore, the motor shaft 20 is the disk rotating shaft. Hence, the positional relationship between the disk mounted on the motor mounting section 99 and the motor shaft 20 is important. Therefore, in the motor shaft (20) supporting structure as shown in FIG. 5, the aforementioned positional relation accuracy depends on the positional relation accuracy of the motor shaft 20 and the radial bearing 82, the positional accuracy of a hole 901 formed in the mounting board 90, and the positional accuracy of a fixing hole (not shown) formed in the motor mounting section 99. Hence, when the motor body 80A is mounted on the motor mounting section 99, it is necessary to finely adjust the positional relation between the pick up device and the motor shaft.

In the case of a disk drive device in which an MD is loaded as a disk memory, it is required that the device is decreased in thickness and reduced in size. Hence, it is also required to reduce the thickness of the spindle motor 80. However, in the case of the small DC Motor (i.e., the spindle motor 80) with brushes as shown in FIG. 5, it is necessary to provide a space on the base end side of the motor shaft 20 where brush holders 61 and brushes 62 are to be set. In addition, since an armature 34 together with the motor shaft 20 is rotated, there must be a sufficient gap G between the coil 38 and the upper plate 850 of the motor casing 85. Hence, it is difficult to reduce the thickness of the small DC motor with brushes (the spindle motor 80). On the other hand, if the wall thickness of the upper end surface 88 (the upper plate 850) of the motor casing 85 is decreased, then the strength of holding of the radial bearing 82 held in the upper end face 88 is decreased, so that the motor shaft 20 may be swung.

### SUMMARY OF INVENTION

In view of the foregoing, an object of this invention is to provide a spindle motor in which the squareness of the motor shaft is high in accuracy.

Another object of the invention is to reduce the thickness of a spindle motor.

According to an aspect of the present invention, there is provided a spindle motor comprising:

a motor casing;

a motor body having a motor shaft whose output end portion is protruded from an upper end surface of said motor casing;

a mounting board secured to said motor casing in such a manner as to cover the upper end surface of said motor casing, and serving as a mounting section of said motor body with respect to a body unit on which said motor body is mounted;

a radial bearing which rotatably supports said motor shaft; and

a bearing holding hole formed in said mounting board,

a shaft pull-out hole formed in the upper end surface of said motor casing, the output end portion of said motor shaft is protruded from the upper end surface of said motor casing through said shaft pull-out hole,

wherein said bearing holding hole is formed in such a manner that the central axial line of said bearing holding hole forms right angles with said mounting board, and said radial bearing is held in said bearing holding hole.

According to the present invention, a spindle motor has the squareness of the motor shaft is high in accuracy, and is to reduce the thickness of a spindle motor.

### BRIEF DESCRIPTION OF THE DRAWING(S)

FIG. 1 is a side view, with parts cut away, showing a spindle motor to which the technical concept of the invention is applied;

FIG. 2 is an enlarged sectional view showing essential parts of the spindle motor to which the technical concept of the invention is applied;

The part (a) of FIG. 3 is a vertical sectional view showing a method of securing a mounting board to the upper end surface of a motor casing by using an example of a positioning jig;

The part (b) of FIG. 3 is a vertical sectional view showing a method of securing a mounting board to the upper end surface of the motor casing by using another example of the positioning jig;

FIG. 4 is an explanatory diagram for a description of the internal structure of the spindle motor with the mounting board secured to the upper end surface of the motor casing by using the positioning jig shown in the part (b) of FIG. 3; and

FIG. 5 is a side view, with parts cut away, showing a conventional spindle motor.

### DETAILED DESCRIPTION OF THE INVENTION

A spindle motor, to which the technical concept of the invention is applied, will be described with reference to the accompanying drawings.

### Brief Description of the Whole Structure of a Spindle Motor

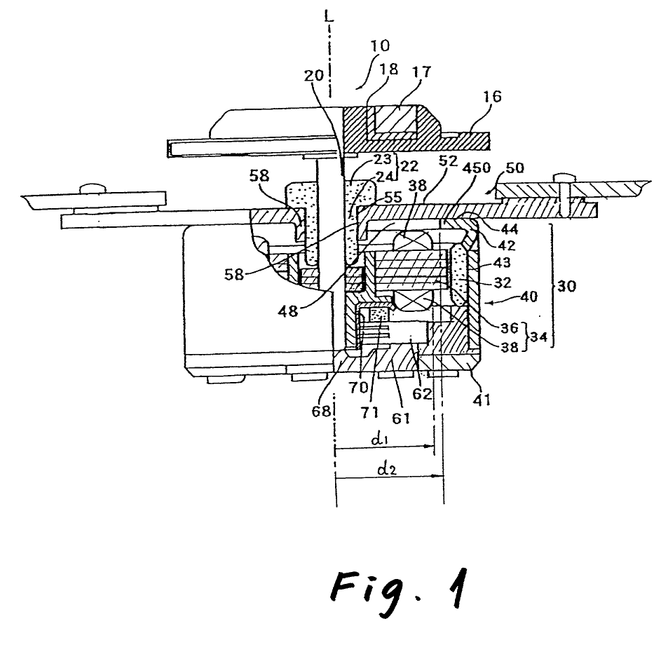

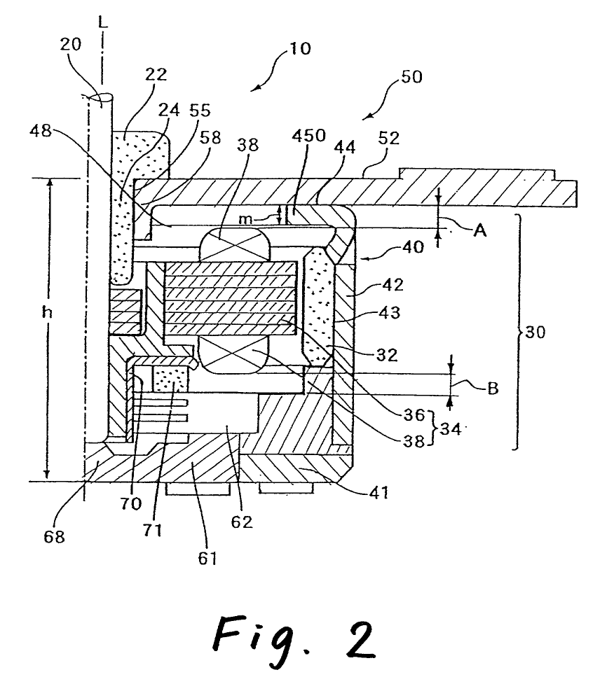

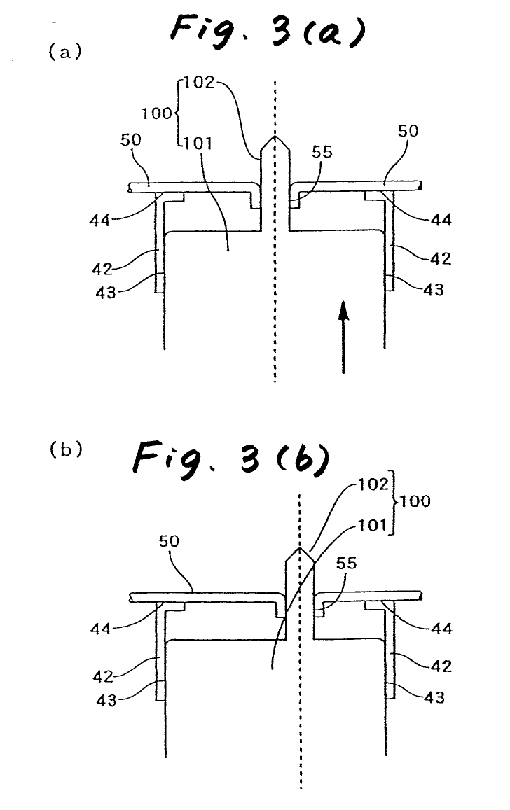

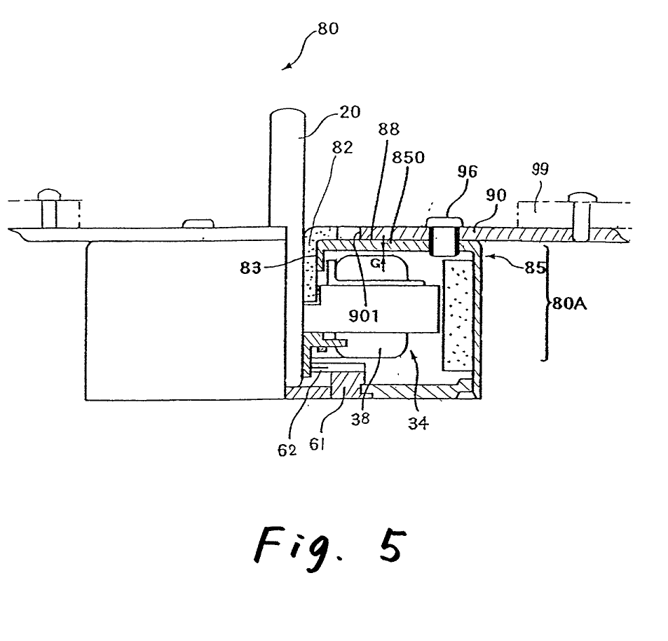

FIG. 1 is a side view, with parts cut away, showing a spindle motor according to the invention, and FIG. 2 is an enlarged sectional view showing essential parts of the spindle motor. The spindle motor shown in FIGS. 1 and 2 is substantially equal in fundamental structure the conventional one shown in FIG. 5. Therefore, in FIGS. 1 and 2, parts corresponding functionally to those already described with reference to FIG. 5 are therefore designated by the same reference numerals or characters.

As shown in FIGS. 1 and 2, the spindle motor 10 is a small DC motor with brushes, and is mounted on a motor mounting section 99 of a disk drive device (a body unit, not shown) adapted to rotate a disk such as an MD.

The spindle motor 10 comprises: a motor body 30 with a motor shaft 20 whose output end portion is protruded from the upper end face 44 of the motor casing 30; and a mounting board 50 secured to the motor casing 40, for instance, by welding in such as manner as to cover the upper end surface 44 of the motor casing 40. The mounting board 50 is the mounting section of the motor body 30 with respect to the motor mounting section 99 of the disk drive device.

An armature 34 is set inside the motor casing 40. The armature 34 comprises: an iron core 36 (having a plurality of protruded poles which are extended radially) secured substantially to the middle of the motor shaft 20, for instance, by press-fitting so that it is rotated together with the motor shaft 20; and a coil 38 wound on the protruded poles of the iron core 36. The motor casing 40 is in the form of a cup. Four-pole-magnetized ring-shaped permanent magnets 32 are secured to the inner cylindrical surface 43 of the side wall 42 of the motor casing 40. The permanent magnets 32 are confronted through a predetermined gap to the outer arcuate surfaces of the protruded poles of the iron core 36.

The base end portion of the motor shaft 20 is supported by a thrust bearing 68 integral with the brush holder 61, and the output end portion is rotatably supported by the radial bearing 22. Of those bearings, the thrust bearing 68 (the brush holder 61) is held on the end board 41 covering the open end of the motor casing 40. The lower end portion of the shaft 20 has a commutator 70, and a varistor (an arc extinguishing element) 71 is provided near the commutator 70. The brushes 62 held by the brush holders 61 are abutted against the commutator 70.

At the central portion of the upper end surface 44 (the upper board 450) of the motor casing 40, no radial bearing 22 is held (unlike the prior art), and instead a shift pull-out hole 48 is formed. Accordingly, the output end portion (the upper portion in the drawing) of the motor shaft 20 is protruded upwardly through the shaft pull-out hole 48.

The shaft pull-out hole 48 is considerably large as a hole through which the output end portion of the motor shaft 20 is pulled out. The shaft pull-out hole 48 is opened at the position where it is laid, as viewed in the direction of the motor axial line L, over the coil winding region inside the motor casing 40. That is, the shaft pull-out hole 48 is opened substantially at the central portion of the upper end surface 44 of the motor casing 40 in such a manner that its diameter d2 is slightly larger than the outside diameter d1 of the wound part of the coil 38. Accordingly, the upper end portion of the coil 38 is confronted directly with the lower surface of the mounting board 50 through the shaft pull-out hole 48.

### Radial Bearing Holding Structure

In the embodiment, the radial bearing 22 is secured to the bearing holding hole 55, for instance, by press-fitting which is formed at the center of the mounting board 50. The bearing holding hole 55 is defined by a cylinder 58 which is formed by burring the central portion of the mounting board 50 in such a manner that the cylinder is extended towards the motor casing 40. The radial bearing 22 comprises a cylindrical barrel 24 adapted to receive the motor shaft 20, and a flange 23 which is radially extended from the upper end of the barrel 24. The barrel 24 is extended downwardly through the shaft pull-out hole 48 of the motor casing 40 so that the lower half thereof is located inside the motor casing 40. The flange 23 partially covers the upper surface 52 of the mounting board 50.

### Structure for Mounting the Motor Body on the Body Unit

In the spindle motor 10 thus designed, the motor body 30 is mounted on the disk drive device by securing the mounting board 50 to the motor mounting section 99 of the disk drive device with screws or the like. Under the condition that the motor body 30 is mounted on the motor mounting section 99, the turn table 16 fixedly mounted on in the upper end portion of the motor shaft 20 by press-fitting turns the disk (such as an MD) laid on the upper surface (the disk mounting surface) around the motor axial line L. The turn table 16 is provided with a disk chucking magnet 17, and a yoke 18 for the magnet 17.

Accordingly, in order to rotate the disk horizontally, the motor shaft 20 must be at right angles with the motor mounting section 99. In the embodiment, the burring work for forming the bearing holding hole 55 (the cylinder 58) in the mounting board 50 is so carried out that the central axial line of the bearing holding hole 55 (the cylinder 58) forms right angles with the mounting board 50. In the case where the bearing holding hole 55 is formed at right angles with the mounting board 50 as a reference surface, the radial bearing 22 can be fixed in such a manner that it is at right angles with respect to the mounting board 55. Hence, the squareness of the mounting board 50 with the motor shaft 20 can be obtained correctly with ease.

### Assembling Work of the Mounting Board 50 and the Motor Casing 40

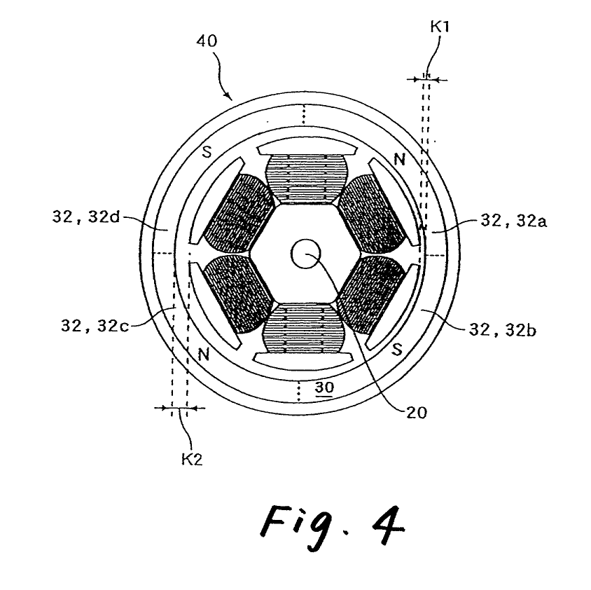

Of the manufacturing steps of the spindle motor 10 thus designed, a step of fixing the mounting board 50 to the upper end surface 44 of the motor casing 40 will be described with reference to the parts (a) and (b) of FIG. 3. The parts (a) and (b) of FIG. 3 are vertical sectional views for a description of methods of securing mounting boards to the upper end face 44 of the motor casing 44 with positioning jigs, respectively. FIG. 4 is an explanatory diagram showing the internal arrangement of the spindle motor in which the mounting board is secured to the upper end surface of the motor casing by using the positioning jig shown in the part (b) of FIG. 3.

As shown in the part (a) of FIG. 3, in order to position the mounting board 50 on the upper end surface 44 of the motor casing 40, a positioning jig 100 is employed which comprises: a large diameter shaft 101 whose outside diameter is substantially equal to the inside diameter of the motor casing 40; and a small diameter shaft 102 which has an outside diameter substantially equal to the inside diameter of the baring holding hole 55 and which is extended vertically from the upper end face of the large diameter shaft. The positioning jig 100 is used as follows: The positioning jig 100 is inserted into the motor casing 40 halfway in the direction of the arrow so that the small diameter shaft 102 is protruded from the upper end surface 44 of the motor casing 40. Under this condition, the mounting board 50 is set on the upper end surface 44 of the motor casing 40 in such a manner that the bearing holding hole 55 is put on the small diameter shaft 102. As a result, the motor casing 40 and the mounting board 50 can be positioned with respect to each other according to the configuration of the positioning jig 100. Thereafter, the motor casing 40 is fixedly welded to the mounting board 50.

In the positioning jig 100, as shown in the part (a) of FIG. 3, the small diameter shaft 102 is protruded from the center of the upper end face of the large diameter shaft 101. With the positioning jig 100, the motor casing 40 can be secured to the mounting board 50 in such a manner that the bearing holding hole 55 of the mounting board 50 is positioned at the center of the upper end surface 44 of the motor casing 40. Hence, as shown in FIGS. 1 and 2, after the radial bearing 22 is secured to the bearing holding hole 55 of the mounting board 50, the motor shaft 20 integral with the armature 34 is inserted into the baring holding hole 55, so that the motor shaft 20 is arranged at the central position of the motor casing 40. Under this condition, the distance between the permanent magnets secured to the inner cylindrical surface 43 of the side wall (board) 42 of the motor casing 40 and the outer arcuate surfaces of the iron core 36 is constant as viewed in the circumferential direction.

In the case of the part (b) of FIG. 3, the positioning jig 100 has a large diameter shaft 101, and a small diameter shaft 102 which is located away from the center of the upper end face of the large diameter shaft 101. With the positioning jig 100, the motor casing 40 can be secured to the mounting board 50 in such a manner that the bearing holding hole 55 of the mounting board 50 is positioned away from the center of the upper end surface 44 of the motor casing 40. Hence, as shown in FIGS. 1 and 2, after the radial bearing 22 is secured to the baring holding hole 55 of the mounting board 50, the motor shaft 20 integral with the armature 34 is inserted into the bearing holding hole 55. As a result, as shown in FIG. 4, the motor shaft 20 is positioned away from the center of the motor casing 40. Under this condition, the distance between the four-pole magnetized permanent magnet 32 on the inner cylindrical surface 43 of the side wall (board) 42 of the motor casing and the outer arcuate surfaces of the protruded poles of the iron core 36 fixedly mounted on the motor shaft 20 are variable as viewed in the direction of the circumferential direction. For instance, on the right side of FIG. 4, at the polarization point of the drive magnet 32a (S pole) and the drive magnet 32b (N pole), the distance between the magnet and the outer arcuate surface of the iron core 36 is k1. At the position symmetrical with the aforementioned position; that is, at the polarization point of the drive magnet 32d (S pole) and the drive magnetic 32d (N pole), the distance between the magnet and the outer arcuate surface of the iron core 36 is K2. And K2>K1. Accordingly, because of the unbalance of magnetic force corresponding to the amount of offset of the motor shaft 20 from the center of the motor casing 40, the side pressure is applied to the shaft 20 which pulls the shaft including the armature 34 in a predetermined direction at all times. Therefore, the shaft 20 is rotated while being pushed against one side of the inner cylindrical surface of the radial bearing 22, and therefore no shaft swing nor shaft vibration occurs.

As was described above, in the spindle motor 10 of the invention, the radial bearing supporting the output end portion of the motor shaft 20 is held by the mounting board 50 for the body unit. Therefore, in the spindle motor of the invention, unlike the spindle motor in which the radial bearing supporting the output end portion of the motor shaft 20 is held on the upper end surface 44 of the motor casing 40, the accurate squareness of the motor shaft 20 with respect to the mounting board 50 can be directly obtained. Accordingly, the squareness of the motor shaft 20 on the body unit is not affected by the deviation in the squareness of the motor shaft 20 with respect to the upper end surface 44 of the motor casing 20. Hence, when the motor body 30 is mounted on the motor mounting section 99 of the body unit through the motor mounting board 50, the deviation in the squareness of the motor shaft 20 with respect to the motor mounting section 99 may be within 0±0.15° or preferably within 0±0.10° . Therefore, the spindle motor 10 of the invention can be used for the disk such as a DVD which is high in recording density.

As is seen from FIG. 2, the upper end surface 44 of the motor casing 40 is not directly related to the supporting of the motor shaft 20. Therefore, in the upper board 450 corresponding to the upper end surface 44, a large shaft pull-out hole 48 may be formed which is opened in such a manner that it is positioned over the wound portions of the coil 38 of the armature 34 in the direction of the motor axial line L. That is, the upper board 450 of the motor casing 40 should have a margin which is large enough to position and fix the mounting board 50. This feature makes it possible to form the large shaft pull-out hole 48. Therefore, as the upper end portion of the coil 38 of the armature 34 goes into the shaft pull-out hole 48 of the motor casing 40, the positional relation between the armature 34 and the motor casing 40 can be compressed in the direction of the motor axial line L. Accordingly, in the spindle motor 10, the distance (dimension) h between the lower end of the motor casing 40 to the upper end surface of the mounting board 50 can be greatly decreased. Hence, although the spindle motor 10, having the iron core 36 and the permanent magnets 32, is small in size and high in output torque, it can be miniaturized to the extent that the casing outside diameter is 14 mm or less and the height (thickness) is 9 mm or less. Thus, the spindle motor of the invention is suitable as a motor which is mounted on a body unit such as a disk drive device for MDs which is required to be reduced in thickness as much as possible.

Especially, in the spindle motor 10 with brushes, the armature 34 is turned together with the motor shaft 20, and therefore the gap A between the coil 38 of the armature 34 and the upper board 450 corresponding to the upper end surfaces 44 of the motor casing 40 must be large enough, and in addition it is necessary to have a large gap B below the coil 38 of the armature 34. In the conventional structure, it is difficult to reduce the thickness of the motor. On the other hand, in the spindle motor of the invention, the shaft pull-out hole which is large in diameter is formed as was described above, and therefore it is possible to design the motor so that the coil 38 of the armature 34 is turned in the shaft pull-out hole 48. That is, in this case, the coil 38 of the armature 34 should not be in contact with the lower surface of the mounting board, and therefore the dimension corresponding to the wall thickness m of the upper board 450 of the motor casing 40 can be utilized, as it is, as a space for arranging the armature 34. Therefore, the invention is effective in reduction of the thickness of the spindle motor 10.

Furthermore, the radial bearing 22 is held by the mounting board 50 for the body unit. Therefore, in the case where the bearing hold hole 55 (the cylinder 58) is formed in the mounting board 50, merely by setting the central axial line of the bearing holding hole 55 (the cylinder 58) to 90° with respect to the mounting board 50, the radial bearing 22 can be fixed at right angles with respect to the mounting board 50. Therefore, the correct squareness of the motor shaft 20 with respect to the mounting board 50 can be obtained with ease.

Moreover, in the spindle motor 10 of the invention, the bearing supporting the motor shaft 20 radially is of a canti-levered structure; that is, it is only the radial bearing 22 which is held in the bearing holding hole 55 of the mounting board 50. Accordingly, the posture of the motor shaft 20 can be controlled only with the radial bearing held by the bearing holding hole 55 of the mounting board 50, and therefore, the squareness of the motor shaft 20 with respect to the mounting board 50 can be positively obtained.

In order to employ a screw holding structure to fix the mounting board 50 and the motor casing 40, it is necessary to form threaded holes in the motor casing 40. If shavings formed when the threaded holes are formed go in the motor casing 40, noise may be formed by the motor, or the rotation of the motor may become unsatisfactory. However, in the embodiment, fixing the mounting board 50 and the stator casing 40 is achieved by welding such as spot welding and plasma welding. Therefore, the spindle motor of the invention is free from the above-described difficulties.

### Another Embodiment(s)

In the above-described embodiment, the technical concept of the invention is applied to a spindle motor 10 having brushes; however, it goes without saying that the technical concept of the invention is applicable to a brush-less spindle motor.

Furthermore, in the above-described embodiment, the large shaft pull-out hole 48 which is opened so that it is over the wound portion of the coil 38 of the armature 34 in the motor axial direction L, is formed substantially at the center of the upper end surface 44 of the motor casing 44. However, the upper board 450 corresponding to the upper end surface of the motor casing 40 may be reduced in thickness by pressing to obtain a space inside the motor casing 40, thereby to reduce the thickness of the spindle motor. In this case, too, the upper board 450 corresponding to the upper end surface 44 of the motor casing 40 does not support the motor shaft 20, and therefore the strength of holding the motor shaft 20 will not be decreased.

What is claimed is:

1. A spindle motor comprising:
a motor casing;
a motor body having a motor shaft whose output end portion is protruded from an upper end surface of said motor casing;
a mounting board secured to said motor casing in such a manner as to cover the upper end surface of said motor casing, and serving as a mounting section of said motor body with respect to a body unit on which said motor body is mounted;
a radial bearing which rotatably supports said motor shaft; and
a bearing holding hole formed in said mounting board,
a shaft pull-out hole formed in the upper end surface of said motor casing, the output end portion of said motor shaft is protruded from the upper end surface of said motor casing through said shaft pull-out hole,
wherein said bearing holding hole is formed in such a manner that the central axial line of said bearing holding hole forms right angles with said mounting board, and said radial bearing is held in said bearing holding hole.

2. A spindle motor as claimed in claim 1, further comprising:
an armature having a plurality of protruded poles which are turned together with said motor shaft, and a coil wound on said protruded poles,
wherein said shaft pull-out hole of said motor casing is larger in diameter than the outer periphery of said coil.

3. A spindle motor as claimed in claim 1, wherein said bearing holding hole is made up of a cylinder which is formed in the central portion of said mounting board by burring in such a manner that said cylinder is protruded inside said motor casing.

4. A spindle motor as claimed in claim 1, wherein said motor shaft is radially supported by only said radial bearing which is held in said bearing holding hole of said mounting board.

5. A spindle motor as claimed in claim 1, wherein said motor casing and said mounting board are secured in such a manner that said bearing holding hole of said mounting board is located at the central position of the upper end surface of said motor casing.

6. A spindle motor as claimed in claim 1, wherein said motor casing and said mounting board are secured so that said bearing holding hole of said mounting board is shifted from the central position of the upper end surface of said motor casing.
